(19) United States
(12) Patent Application Publication
(10) Pub. No.: US 2026/0113740 A1
(43) Pub. Date: Apr. 23, 2026

(54) METHOD FOR CONFIGURING BAND, METHOD FOR INDICATING BAND, TERMINAL, NETWORK DEVICE, AND STORAGE MEDIUM

(71) Applicant: Beijing Xiaomi Mobile Software Co., Ltd., Beijing (CN)

(72) Inventor: Shengxiang GUO, Beijing (CN)

(73) Assignee: Beijing Xiaomi Mobile Software Co., Ltd., Beijing (CN)

(21) Appl. No.: 19/115,096

(22) PCT Filed: Sep. 26, 2022
(86) PCT No.: PCT/CN2022/121337

§ 371 Date: Mar. 25, 2025

(51) Int. Cl. H04W 72/0453

(52) U.S. Cl. CPC H04W 72/0453

(57) ABSTRACT

A method for configuring a band, including: receiving band configuration signaling sent by a network device, where the band configuration signaling is configured to indicate at least one band group, the band group includes at least two bands, and the at least two bands in the band group support switching in at least one direction.

### CROSS-REFERENCE TO RELATED APPLICATION

The present application is a U.S. National Stage of International Application No. PCT/CN2022/121337, filed on Sep. 26, 2022, the contents of all of which are incorporated herein by reference in their entireties for all purposes.

### BACKGROUND OF THE INVENTION

A solution in which a terminal can perform uplink transmission by using bands is provided in a mobile communication system. At present, a terminal can perform switching for uplink antennas, that is, perform switching for bands indicated by the uplink antennas. However, how to realize bands switching in a case where the terminal supports different numbers of bands has become an urgent problem to be solved.

### SUMMARY OF THE PRESENT INVENTION

The present application relates to the field of mobile communications, and in particular, to a method for configuring a band, a method for indicating a band, a terminal, a network device, and a storage medium.

According to an aspect of the present application, a method for configuring a band is provided. The method is performed by a terminal, and includes:
receiving band configuration signaling sent by a network device, where the band configuration signaling is configured to indicate at least one band group, the band group includes at least two bands, and the at least two bands in the band group support switching in at least one direction.

According to another aspect of the present application, a method for indicating a band is provided. The method is performed by a network device, and includes:
sending band configuration signaling to a terminal, where the band configuration signaling is configured to indicate at least one band group, the band group includes at least two bands, and the at least two bands in the band group support switching in at least one direction.

According to another aspect of the present application, a terminal is provided. The terminal includes: one or more processors; a transceiver connected to the one or more processors; and a memory configured to store processor-executable instructions, where the one or more processors are collectively configured to load and execute the executable instructions to perform the method for configuring a band as in the above aspect.

According to another aspect of the present application, a network device is provided. The network device includes: one or more processors; a transceiver connected to the one or more processors; and a memory configured to store processor-executable instructions, where the one or more processors are collectively configured to load and execute the executable instructions to perform the method for indicating a band as in the above aspect.

According to another aspect of the present application, a non-transitory computer-readable storage medium is provided. The readable storage medium stores an executable program codes, where the executable program codes are loaded and executed by one or more processors to implement the method for configuring a band or the method for indicating a band as in the above aspect.

### BRIEF DESCRIPTION OF DRAWINGS

In order to more clearly illustrate the technical solution in the embodiments of the present application, the accompanying drawings to be used in the description of the embodiments will be briefly introduced below. It will be apparent that the accompanying drawings in the following description are merely some of the embodiments of the present application, and other accompanying drawings can be obtained according to these accompanying drawings for those skilled in the art without creative efforts.

FIG. 1 shows a block diagram of a communication system provided in an example of the present application.

FIG. 2 shows a flowchart of a method for configuring a band provided in an example of the present application.

FIG. 3 shows a flowchart of a method for indicating capability provided in an example of the present application.

FIG. 4 shows a block diagram of a device for configuring a band provided in an example of the present application.

FIG. 5 shows a block diagram of a device for configuring a band provided in another example of the present application.

FIG. 6 shows a block diagram of a device for indicating a band provided in an example of the present application.

FIG. 7 shows a block diagram of a device for indicating a band provided in another example of the present application.

FIG. 8 shows a schematic structural diagram of a communication device provided in an example of the present application.

### DETAILED DESCRIPTION OF THE PRESENT INVENTION

In order to make the purpose, technical solution and advantages of the present application clearer, the implementations of the present application will be described in further detail below in conjunction with the accompanying drawings.

Here, examples will be illustrated in detail, examples of which are expressed in the accompanying drawings. When the following description refers to the accompanying drawings, the same numbers in different accompanying drawings represent the same or similar elements unless otherwise indicated. The implementations as described in the following examples do not represent all the implementations consistent with the present application, and rather, are merely examples of devices and methods consistent with some aspects of the present application as detailed in the appended claims.

The terms used in the present application are for the sole purpose of describing particular embodiments and are not intended to limit the present application. The singular forms of “a”, “an”, “the”, and “this” used in the present application and the appended claims are also intended to encompass the plural form, unless the context clearly indicates otherwise. It is also to be understood that the term “and/or” as used herein refers to and encompasses any or all possible combinations of one or more of listed items in association.

It is to be understood that although the terms such as first, second and third may be used in the present application to describe various information, such information is not to be limited to these terms. These terms are used merely to distinguish the same type of information from one another. For example, without departing from the scope of the present application, first information may also be referred to as second information, and similarly, second information may also be referred to as first information. For example, the word “if” as used herein may be interpreted as “at . . . ” or “when . . . ” or “in response to determining” depending on the context.

It needs to be noted that the information (including, but not limited to, user equipment information, user personal information, etc.), data (including, but not limited to, data for analysis, stored data, displayed data, etc.), and signals involved in the present application are authorized by the user or fully authorized by the parties, and the collection, usage, and processing of the relevant data are required to comply with relevant laws, regulations, and standards of the relevant countries and regions.

The terms involved in the present application are explained first.

Band: a band refers to a frequency range. The band may have an identifier, and bands with different identifiers correspond to different frequency ranges. For example, bands include band 1, band 22, band72, etc., each band corresponding to one frequency range.

Band group: a band group includes at least two bands supporting switching in at least one direction. Moreover, the band group includes at least one band subgroup, each of band subgroups includes at least two bands, and the at least two bands in the band subgroup support switching in at least one direction.

Band switching: a terminal supports at least two uplink antennas and at least one band. Each uplink antenna can indicate one band, and one band is indicated by at most two uplink antennas. Indicating means that the terminal may send uplink data on the indicated band by means of the uplink antennas, and band switching means that one uplink antenna used by the terminal is switched from indicating one band to another.

Switching in one direction means that the terminal may switch from a first band to a second band but not from the second band to the first band.

Application scenarios of the present application are described next.

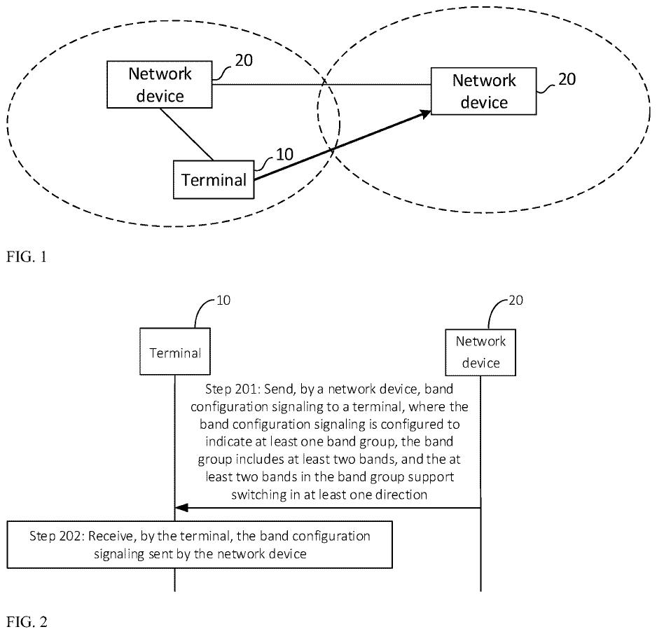

FIG. 1 shows a block diagram of a communication system provided in an example of the present application. The communication system may include: a terminal 10 and a network device 20.

There may usually be a plurality of terminals 10, and one or more terminals 10 may be distributed within a cell managed by each network device 20. The terminals 10 may include a variety of handheld devices, in-vehicle devices, wearable devices, computing devices, or other processing devices connected to a wireless modem with a wireless communication function, as well as various forms of User Equipments (UEs), Mobile Stations (MSs), etc. For ease of description, the devices mentioned are collectively referred to as terminals in the embodiments of the present application.

The network devices 20 are a kind of devices deployed in an access network to provide the wireless communication function for the terminals 10. For ease of description, the devices providing the wireless communication function for the terminals 10 are collectively referred to as network devices in the embodiments of the present application. A connection may be established between the network devices 20 and the terminals 10 via an air interface, so that communication, including signaling and data interaction, is performed through the connection. There may be a plurality of network devices 20, and communication between two adjacent network devices 20 may also be performed in a wired or wireless manner. The terminals 10 may perform beam report transmission between different network devices 20, that is, establish a connection with different network devices 20.

The network devices 20 may include various forms of macro base stations, micro base stations, relay stations, access points, etc. In a system using different wireless access technologies, the names of the devices having functions of the network devices may be different, which, for example, are referred to as gNodeB or gNB in a 5G NR (New Radio) system. As communication technologies evolve, the name “network device” may change.

The “5G NR system” in the embodiments of the present application may also be referred to as a 5G system or an NR system, and those skilled in the art can understand the meaning of the system. The technical solution described in the embodiments of the present application may be applicable to the 5G NR system or a subsequent evolutionary system of the 5G NR system.

FIG. 2 shows a flowchart of a method for configuring a band provided in an example of the present application, which flowchart may be, for example, applied to a terminal and a network device as shown in FIG. 1. The method includes at least part of the following content.

Step 201: Sending, by a network device 20, band configuration signaling to a terminal 10, where the band configuration signaling is configured to indicate at least one band group, the band group includes at least two bands, and the at least two bands in the band group support switching in at least one direction.

Step 202: Receiving, by the terminal 10, the band configuration signaling sent by the network device 20.

In an embodiment of the present application, the terminal will be informed of at least one band supported by the terminal itself, and the network device will also configure a band group for the terminal so that the terminal can perform band switching based on the at least one band included in the band group.

The switching in one direction means that the terminal supports the switching from a first band to a second band but not from the second band to the first band. Supporting switching in at least one direction means that the terminal supports at least switching from the first band to the second band but not from the second band to the first band. The terminal may also support switching of at least two bands to each other.

The band configuration signaling is configured to indicate at least one band group, and each band group includes at least two bands. The at least two bands in the band group support switching in at least one direction, that is, the network device may send band configuration signaling to the terminal so as to configure the at least one band group for the terminal via the band configuration signaling. The terminal can, upon receiving the band configuration signaling, determine the at least one band group configured by the network device.

In some embodiments, the band group includes at least one band subgroup, and each of the band subgroups includes at least two bands. The at least two bands in the band subgroup support switching in at least one direction.

For example, one band group includes one band subgroup that includes 2 bands, which means that the terminal supports that the 2 bands support switching in at least one direction. Alternatively, one band group includes 3 band subgroups with each including 2 bands, which means that the 2 bands in each band group support switching in at least one direction.

In some embodiments, the band configuration signaling is in the form of at least one of: radio resource control (RRC) signaling, a media access control control element (MAC CE), or downlink control information (DCI).

That is to say, the band configuration signaling is in the form of the RRC signaling, or the band configuration signaling is in the form of the MAC CE, or the band configuration signaling is in the form of the DCI signaling.

The present application provides a solution for distinguishing, based on bands grouping, whether the bands can be switched, so that band switching can be performed based on whether each band group is active. Thus, dynamic bands switching for the terminal is realized and energy consumption of the terminal for bands switching is reduced.

The embodiment shown in FIG. 2 illustrates that a network device may configure at least one band group for a terminal via band configuration signaling. The following continues to illustrate how to configure, via the band configuration signaling, a band group to be active.

First: The band configuration signaling includes bits whose number is a first number (or a first number of bits), each of the band subgroups in the at least one band group corresponds to one bit in the band configuration signaling, each bit corresponding to each of the band subgroups is configured to indicate whether the band subgroup is active, and the band subgroup includes at least two bands.

The first number is agreed upon by a communication protocol or set by the network device, which is not limited in the embodiments of the present application. The first number is N, N is a positive integer greater than or equal to 1. The band configuration signaling includes N bits. For example, the first number N is 4, 6, or other values.

In an embodiment of the present application, by setting bits whose number is the first number in the band configuration signaling, the network device indicates whether the band subgroups included in the band group are active by using each of the bits whose number is the first number, that is, one of the bits whose number is a first number included in the band configuration signaling corresponds to one band subgroup, and the bit indicates whether the corresponding band subgroup is active.

For example, the network device configures one band group for the terminal, and the band group includes 3 band subgroups, namely, band subgroup 1, band subgroup 2, and band subgroup 3, band subgroup 1 including band 1 and band 2, band subgroup 2 including band 1 and band 3, and band subgroup 3 including band 2 and band 3. The band configuration signaling indicates whether the 3 band subgroups are active by using 3 bits xxx which correspond one-to-one with the 3 band subgroups, where a first x corresponds to band subgroup 1, a second x corresponds to band subgroup 2, and a third x corresponds to band subgroup 3.

Optionally, the bits whose number is the first number in the present application is represented by using a bitmap. The bitmap includes the bits whose number is the first number.

In some embodiments, if the bit corresponding to a band subgroup is 0, it means that the band subgroup is inactive; if the bit corresponding to the band subgroup is 1, it means that the band subgroup is active. Alternatively, if the bit corresponding to the band subgroup is 0, it means that the band subgroup is active; if the bit corresponding to the band subgroup is 1, it means that the band subgroup is inactive.

In some embodiments, the first number of bits included in the band configuration signaling will be greater than a second number of band subgroups included in the band group. In this case, the terminal needs to determine which bits are valid. The second number is M, M is a positive integer greater than or equal to 1.

Optionally, in a case where the second number of band subgroups included in the band group is less than the first number, most significant bits whose number is the second number among the bits whose number is the first number correspond one-to-one with the band subgroups in the band group.

The most significant bits whose number is the second number refer to first bits whose number is the second number among the bits whose number is the first number. For example, in a case where the bits whose number is the first number are xyzmnl and the second number is 4, the most significant bits whose number is the second number are xyzm.

Optionally, in a case where the second number of band subgroups included in the band group is less than the first number, least significant bits whose number is the second number among the bits whose number is the first number correspond one-to-one with the band subgroups in the band group.

The least significant bits whose number is the second number refer to last bits whose number is the second number among the bits whose number is the first number. For example, in a case where the bits whose number is the first number are xyzmnl and the second number is 4, the least significant bits whose number is the second number are zmnl.

Optionally, the second number of band subgroups included in the band group is determined based on the number of bands supported by the terminal.

In an embodiment of the present application, the band subgroups configured by the network device for the terminal are determined based on the bands supported by the terminal itself. That is to say, the network device performs grouping based on the bands supported by the terminal so as to obtain band subgroups, and thus the second number of band subgroups included in the band group is determined based on the number of bands supported by the terminal.

In some embodiments, the terminal may further report its own capability information to the network device, where the capability information is configured to indicate at least one band supported by the terminal.

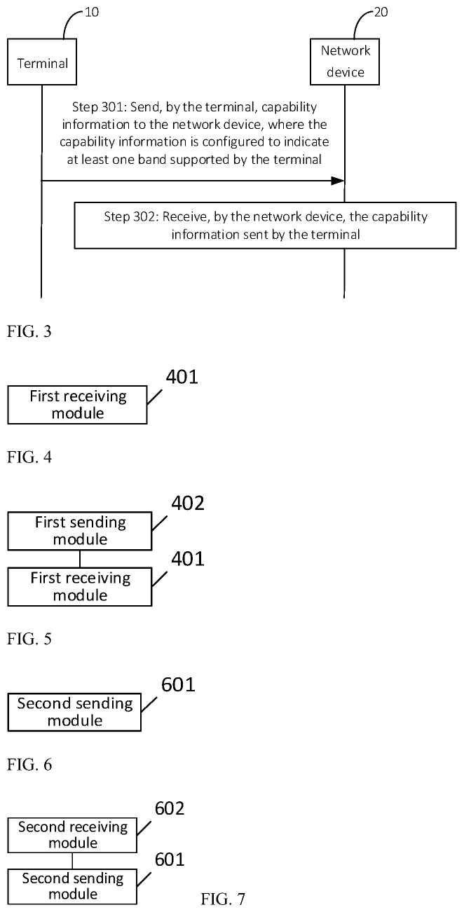

FIG. 3 shows a flowchart of a method for indicating capability provided in an example of the present application, which may be, for example, applied to a terminal and a network device as shown in FIG. 1. The method includes at least part of the following content.

Step 301: Sending, by the terminal 10, capability information to the network device 20, where the capability information is configured to indicate at least one band supported by the terminal 10.

Step 302: Receiving, by the network device 20, the capability information sent by the terminal 10.

The terminal sends the capability information to the network device, where the capability information is configured to indicate at least one band supported by the terminal. Thus, upon receiving the capability information, the network device can determine, based on the capability information, the at least one band supported by the terminal.

For example, the terminal may report a band pair to the network device, that is, report 2 bands supported by the terminal itself to the network device. Alternatively, the terminal may report 3 bands to the network device, or the terminal may report 4 bands to the network device.

Optionally, the capability information further includes at least one of: a number of the bands; at least one of indexes of the bands or identifiers of the bands; or an index of the band group.

It needs be noted that the steps performed by the terminal in the embodiments of the present application may form a new embodiment separately, and the steps performed by the network device may also form a new embodiment separately.

In some embodiments, the number of bands supported by the terminal may be 1, 2, 3, 4, or other values, which is not limited in the embodiments of the present application.

The following describes the number of bands supported by the terminal as 3 and 4.

For example, if the number of bands supported by the terminal is 3, namely, band A, band B, and band C, a band group may be constituted, which includes 3 band subgroups, namely, band subgroup 1, band subgroup 2, and band subgroup 3, band subgroup 1 including band A and band B, band subgroup 2 including band A and band C, and band subgroup 3 including band B and band C.

Optionally, the band group may also be represented in a table. For example, referring to Table 1, the terminal supports band A, band B, and band C, which are divided into 3 band subgroups.

TABLE 1

band A + band B + band C
band A + band B, band A + band C, band B + band C

If the band configuration signaling includes 6 bits, namely, 100011, and the number of band subgroups is 3, the terminal determines that 3 least significant bits are valid, meaning that the terminal supports band subgroup 2 and band subgroup 3; the terminal determines that 3 most significant bits are valid, meaning that the terminal supports band subgroup 1.

For another example, if the number of bands supported by the terminal is 4, namely, band A, band B, band C, and band D, a band group may be constituted, which includes 6 band subgroups, namely, band subgroup 1, band subgroup 2, band subgroup 3, band subgroup 4, band subgroup 5, and band subgroup 6, band subgroup 1 including band A and band B, band subgroup 2 including band A and band C, band subgroup 3 including band A and band D, band subgroup 4 including band B and band C, band subgroup 5 including band B and band D, and band subgroup 6 including band C and band D.

Optionally, the band group may also be represented in a table. For example, referring to Table 2, the terminal supports band A, band B, band C, and band D which are divided into 6 band subgroups.

TABLE 2
band A + band B + band C + band D
band A + band B, band A + band C, band A + band D, band B + band C,
band B + band D, band C + band D

If the band configuration signaling includes 6 bits, namely, 100011, and the number of band subgroups is 6, the terminal determines that all bits are valid, meaning that the terminal supports band A+band B, band B+band D, and band C+band D.

In the solution provided in the embodiments of the present application, based on each bit in the band configuration signaling which indicate whether the corresponding band subgroup is active, the network device may perform band switching based on whether each band group is active. Thus dynamic bands switching for the terminal is realized and energy consumption of the terminal for bands switching is reduced.

It needs to be noted that the band subgroups included in the band group are determined based on the number of bands supported by the terminal. It can also be understood that if the number of bands supported by the terminal is 3, it is determined by default that the band group includes 3 band subgroups; if the number of bands supported by the terminal is 4, it is determined by default that the band group includes 6 band subgroups.

Second: The band configuration signaling includes the bits whose number is the first number, the bits whose number is the first number indicate an index identifier, the index identifier has a correspondence relationship with the band group, and the bits whose number is the first number are configured to indicate that the at least one band group corresponding to the indicated index identifier is active by using the indicated index identifier.

In an embodiment of the present application, the terminal stores the index identifier having a correspondence relationship with the band group. The network device can indicate the index identifier by sending the band configuration signaling including the bits whose number is the first number to the terminal, and the terminal determines, based on the index identifier of the bits whose number is the first number, that the corresponding band group is active.

In some embodiments, the band group includes at least one band subgroup. In a case where the terminal determines that the indicated band group is active, it is determined that the at least one band subgroup included in the band group is active.

In some embodiments, the terminal stores a plurality of correspondence relationships, each of which corresponds to the number of bands supported by the terminal, that is, the terminal will firstly determine, upon receiving the band configuration signaling, correspondence relationships between the corresponding index identifiers and band groups based on the number of bands supported by the terminal itself, and then determine corresponding band groups based on the index identifiers indicated by the band configuration signaling and the determined correspondence relationships.

Optionally, the plurality of correspondence relationships are stored in different tables, respectively. The terminal can determine, based on the number of bands supported by the terminal itself, the tables in which the corresponding correspondence relationships are located.

For example, the number of bands supported by the terminal may be 1, 2, 3, 4, or other values. The following describes the number of bands supported by the terminal as 3 or 4.

For example, if the terminal supports 3 bands, namely, band A, band B, and band C, the correspondence relationships between the index identifiers and band groups are as shown in Table 3.

TABLE 3

| Index Identifier | Band Group |
|---|---|
| 0 | band A + band B + band C |
| 1 | band A + band B, band A + band C |
| 2 | band A + band B, band B + band C |
| 3 | band A + band C, band B + band C |
| 4 | band A + band B |
| 5 | band A + band C |
| 6 | band B + band C |
| 7 | — |

For example, if the terminal supports 4 bands, namely, band A, band B, band C, and band D, the correspondence relationships between the index identifiers and band groups are as shown in Table 4.

TABLE 4

| Index Identifier | Band Group |
|---|---|
| 0 | band A + band B + band C + band D |
| 1 | band A + band B + band C |
| 2 | band A + band B + band D |
| 3 | band A + band C + band D |
| 4 | band B + band C + band D |
| 5 | band A + band B |
| 6 | band A + band C |
| 7 | band A + band D |
| 8 | band B + band C |
| 9 | band B + band D |
| 10 | band C + band D |
| 11 | band A + band B, band C + band D |
| 12 | band A + band C, band B + band D |
| 13 | band A + band D, band B + band C |
| 14 | — |
| 15 | — |

In some embodiments, the first number of bits included in the band configuration signaling be greater than a third number of bands supported by the terminal. In this case, the terminal needs to determine which bits are valid. The third number is P, P is a positive integer greater than or equal to 1.

Optionally, in a case where the third number of bands supported by the terminal is less than the first number, most significant bits whose number is a third number among the bits whose number is the first number indicate the index identifier.

The most significant bits whose number is a third number refer to first bits whose number is the third number among the bits whose number is the first number. For example, in a case where the bits whose number is the first number are xyzmnl and the third number is 4, the most significant bits whose number is the third number are xyzm.

Optionally, in a case where the third number of bands supported by the terminal is less than the first number, least significant bits whose number is the third number among the bits whose number is the first number indicate the index identifier.

The least significant bits whose number is the third number refer to last bits whose number is the third number among the bits whose number is the first number. For example, in a case where the bits whose number is the first number are xyzmnl and the third number is 4, the least significant bits whose number is the third number are zmnl.

In the following, in a case where the number of bands supported by the terminal is 3, the correspondence relationships shown in Table 3 are used as an example for illustration. In a case where the band configuration signaling includes 4 bits, namely, 0000, it is determined that the indicated index identifier is index identifier 0 and that the terminal supports band A+band B+band C.

Optionally, the plurality of correspondences are stored in the same table, respectively, and different correspondences are located in different columns. For example, the number of bands supported by the terminal may be 1, 2, 3, 4, or other values. The following describes the number of bands supported by the terminal as 3 or 4.

For example, if the terminal supports 3 bands, namely, band A, band B, and band C, as well as 4 bands, namely, band A, band B, band C, and band D, the correspondence relationships between the index identifiers and band groups are as shown in Table 5.

TABLE 5

| Index | | |
|---|---|---|
| Identifier | Band Group Supporting 3 Bands | Band Group Supporting 4 Bands |
| 0 | band A + band B + band C | band A + band B + band C + band D |
| 1 | band A + band B, band A + band C | band A + band B + band C |
| 2 | band A + band B, band B + band C | band A + band B + band D |
| 3 | band A + band C, band B + band C | band A + band C + band D |
| 4 | band A + band B | band B + band C + band D |
| 5 | band A + band C | band A + band B |
| 6 | band B + band C | band A + band C |
| 7 | — | band A + band D |
| 8 | — | band B + band C |
| 9 | — | band B + band D |
| 10 | — | band C + band D |
| 11 | — | band A + band B, band C + band D |
| 12 | — | band A + band C, band B + band D |
| 13 | — | band A + band D, band B + band C |
| 14 | — | — |
| 15 | — | — |

In some embodiments, the first number of bits included in the band configuration signaling be greater than a third number of bands supported by the terminal. In this case, the terminal needs to determine which bits are valid.

Optionally, in a case where the third number of bands supported by the terminal is less than the first number, the most significant bits whose number is the third number among the bits whose number is the first number indicate the index identifier.

The most significant bits whose number is the third number refer to first bits whose number is the third number among the bits whose number is the first number. For example, in a case where the bits whose number is the first number are xyzmnl and the third number is 4, the most significant bits whose number is the third number are xyzm.

Optionally, in a case where the third number of bands supported by the terminal is less than the first number, the least significant bits whose number is the third number among the bits whose number is the first number indicate the index identifier.

The least significant bits whose number is the third number refer to last bits whose number is the third number among the bits whose number is the first number. For example, in a case where the bits whose number is the first number are xyzmnl and the third number is 4, the least significant bits whose number is the third number are zmnl.

In the following, in a case where the number of bands supported by the terminal is 3, the correspondence relationships shown in Table 3 are used as an example for illustration. In a case where the band configuration signaling includes 4 bits, namely, 0000, it is determined that the indicated index identifier is index identifier 0 and that the terminal supports band A+band B+band C.

In the solution provided in the embodiments of the present application, based on the indexes indicated by the bits whose number is the first number in the band configuration signaling, the network device determines the supported band subgroup is active and performs band switching based on whether each band group is active. Thus dynamic bands switching for the terminal is realized and energy consumption of the terminal for bands switching is reduced.

It needs to be noted that the embodiments may be split into new embodiments or combined with other embodiments as new embodiments, and the combination of embodiments is not limited in the present application.

FIG. 4 shows a block diagram of a device for configuring a band provided in an example of the present application. Referring to FIG. 4, the device includes:
a first receiving module 401, configured to receive band configuration signaling sent by a network device, where the band configuration signaling is configured to indicate at least one band group, the band group includes at least two bands, and the at least two bands in the band group support switching in at least one direction.

In some embodiments, the band configuration signaling includes the bits whose number is the first number, each of the band subgroups in the at least one band group corresponds to one bit in the band configuration signaling, each bit corresponding to each of the band subgroups is configured to indicate whether the band subgroup is active, and the band subgroup includes at least two bands.

In some embodiments, the most significant bits whose number is a second number among the bits whose number is the first number correspond one-to-one with the band subgroups in the band group, in a case where the band group comprise the band subgroups whose number is the second number and the second number is less than the first number; or the least significant bits whose number is the second number among the bits whose number is the first number correspond one-to-one with the band subgroups in the band group, in a case where the band group comprise the band subgroups whose number is the second number and the second number is less than the first number.

In some embodiments, the second number of band subgroups included in the band group is determined based on the number of bands supported by the terminal.

In some embodiments, the band configuration signaling includes the bits whose number is the first number. The bits whose number is the first number indicate an index identifier, the index identifier has a correspondence relationship with the band group, and the bits whose number is the first number are configured to indicate that the at least one band group corresponding to the indicated index identifier is active by using the indicated index identifier.

In some embodiments, the most significant bits whose number is a third number among the bits whose number is the first number indicate the index identifier, in a case where the terminal supports bands whose number is the third number and the third number is less than the first number; or the least significant bits whose number is the third number among the bits whose number is the first number indicate the index identifier, in a case where the terminal supports the bands whose number is the third number and the third number is less than the first number.

In some embodiments, the band configuration signaling is in the form of at least one of: RRC signaling, a MAC CE, or DCI signaling.

In some embodiments, referring to FIG. 5, the device includes the first receiving module 401, as described with reference to FIG. 4, and further includes:
a first sending module 402, configured to send capability information to the network device, where the capability information is configured to indicate at least one band supported by the terminal.

In some embodiments, the capability information further includes at least one of: a number of the bands; at least one of indexes of the bands or identifiers of the bands; or an index of the band group.

It needs to be noted that the device provided in the embodiments, in realizing its functions, is merely exemplified by the division of each of the functional modules. In actual application, the functions may be assigned to be accomplished by different functional modules when it is needed, that is, the internal structure of the device may be divided into different functional modules to accomplish all or part of the functions. In addition, the device provided in the embodiments belongs to the same concept with the method embodiments, and its specific realization process is detailed in the method embodiments, which will not be repeated here.

FIG. 6 shows a block diagram of a device for indicating a band provided in an example of the present application. Referring to FIG. 6, the device includes:
a second sending module 601, configured to send band configuration signaling to a terminal, where the band configuration signaling is configured to indicate at least one band group, the band group includes at least two bands, and the at least two bands in the band group support switching in at least one direction.

In some embodiments, the band configuration signaling includes the bits whose number is the first number, each of the band subgroups in the at least one band group corresponds to one bit in the band configuration signaling, each bit corresponding to each of the band subgroups is configured to indicate whether the band subgroup is active, and the band subgroup includes the at least two bands.

In some embodiments, the most significant bits whose number is the second number among the bits whose number is the first number correspond one-to-one with the band subgroups in the band group, in a case where the band group comprise the band subgroups whose number is the second number and the second number is less than the first number; or the least significant bits whose number is the second number among the bits whose number is the first number correspond one-to-one with the band subgroups in the band group, in a case where the band group comprise the band subgroups whose number is the second number and the second number is less than the first number.

In some embodiments, the second number of band subgroups included in the band group is determined based on the number of bands supported by the terminal.

In some embodiments, the band configuration signaling includes the bits whose number is the first number. The bits whose number is the first number indicate an index identifier, the index identifier has a correspondence relationship with the band group, and the bits whose number is the first number are configured to indicate, by using the indicated index identifier, that the corresponding at least one band group is active.

In some embodiments, the most significant bits whose number is the third number among the bits whose number is the first number indicate the index identifier, in a case the terminal supports the bands whose number is the third number and the third number is less than the first number; or the least significant bits whose number is the third number among the bits whose number is the first number indicate the index identifier, in a case where the terminal supports the bands whose number is the third number and the third number is less than the first number.

In some embodiments, the band configuration signaling is in the form of at least one of: RRC signaling, a MAC CE, or DCI signaling.

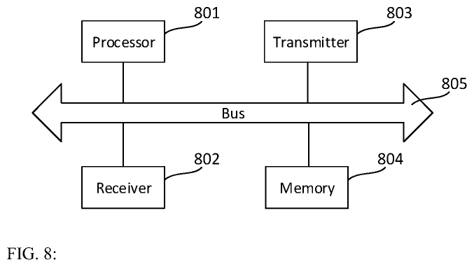

In some embodiments, referring to FIG. 7, the device includes the second sending module 601 as described with reference to FIG. 6 and further includes:
a second receiving module 602, configured to receive capability information sent by the terminal, where the capability information is configured to indicate at least one band supported by the terminal.

In some embodiments, the capability information further includes at least one of: a number of the bands; at least one of indexes of the bands or identifiers of the bands; or index of the band group.

It needs to be noted that the device provided in the embodiments, in realizing its functions, is merely exemplified by the division of each of the functional modules. In actual application, the functions may be assigned to be accomplished by different functional modules when it is needed, that is, the internal structure of the device may be divided into different functional modules to accomplish all or part of the functions. In addition, the device provided in the embodiments belongs to the same concept with the method embodiments, and its specific realization process is detailed in the method embodiments, which will not be repeated here.

FIG. 8 shows a schematic structural diagram of a communication device provided in an example of the present application. The communication device includes: a processor 801, a receiver 802, a transmitter 803, a memory 804, and a bus 805.

The processor 801 includes one or more processing cores, and performs various functional applications and information processing by running software programs and modules.

The receiver 802 and the transmitter 803 may be implemented as a communication component, which may be a communication chip.

The memory 804 is connected to the processor 801 via the bus 805.

The memory 804 may be configured to store at least one program code, and the processor 801 is configured to execute the at least one program code to implement various steps in the method embodiments.

In addition, the communication device may be a terminal or a network device. The memory 804 may be implemented by any type of volatile or non-volatile storage devices or a combination thereof. The volatile or non-volatile storage devices include, but are not limited to: a disk or CD-ROM, an electrically erasable programmable read-only memory (EEPROM), an erasable programmable read-only memory (EPROM), a static ready-to-access memory (SRAM), a read-only memory (ROM), a magnetic memory, a flash memory, and a programmable read-only memory (PROM).

In an example, a non-transitory computer-readable storage medium is further provided. The non-transitory computer-readable storage medium stores an executable program code, where the executable program code is loaded and executed by a processor to implement the method for configuring a band or the method for indicating a band provided in each of the method embodiments and performed by a communication device.

In an example, a chip is provided. The chip includes programmable logic circuits and/or program instructions. The chip, when running on a terminal or a network device, is configured to implement the method for configuring a band or the method for indicating a band as provided in each of the method embodiments.

In an example, a communication system is provided. The communication system includes a terminal and a network device. The terminal is configured to implement the method for configuring a band as described, and the network device is configured to implement the method for indicating a band as described.

In an example, a computer program product is provided. The computer program product, when executed by a processor of a terminal or a network device, is configured to implement the method for configuring a band or the method for indicating a band as provided in each of the method embodiments.

As used herein, the term processor may refer to one processor that performs the defined functions or a plurality of processors that collectively perform defined functions, such that the execution of the individual defined functions may be divided amongst such processors.

Those skilled in the art may understand that all or some of the steps for implementing the embodiments may be accomplished by hardware, or may be accomplished by a program that instructs the relevant hardware. The program may be stored in the non-transitory computer-readable storage medium. The storage medium mentioned may be a read-only memory, a disk, or a CD-ROM, etc.

The included embodiments are merely optional embodiments of the present application, and are not intended to limit the present application. Any modifications, equivalent replacements, improvements, etc. made within the spirit and principles of the present application shall be included in the scope of protection of the present application.

1. A method for configuring a band, performed by a terminal, the method comprising:
receiving band configuration signaling sent by a network device, wherein the band configuration signaling is configured to indicate at least one band group, the band group comprises at least two bands, and the at least two bands in the band group support switching in at least one direction.

2. The method according to claim 1, wherein:
the band configuration signaling comprises bits whose number is a first number;
each of band subgroups in the at least one band group corresponds to one bit in the band configuration signaling;
each bit corresponding to each of the band subgroups is configured to indicate whether the band subgroup is active; and
the band subgroup comprises at least two bands.

3. The method according to claim 2, wherein;
in a case where the band group comprise the band subgroups whose number is a second number and the second number is less than the first number, most significant bits whose number is the second number among the bits whose number is the first number correspond one-to-one with the band subgroups in the band group; or
in a case where the band group comprise the band subgroups whose number is the second number and the second number is less than the first number, least significant bits whose number is the second number among the bits whose number is the first number correspond one-to-one with the band subgroups in the band group.

4. The method according to claim 3, wherein the second number of band subgroups comprised in the band group is determined based on a number of bands supported by the terminal.

5. The method according to claim 1, wherein the band configuration signaling comprises bits whose number is a first number, the bits whose number is the first number indicate an index identifier, the index identifier has a correspondence relationship with the band group, and the bits whose number is the first number are configured to indicate that the at least one band group corresponding to the indicated index identifier is active by using the indicated index identifier.

6. The method according to claim 5, wherein:
in a case where the terminal supports bands whose number is a third number and the third number is less than the first number, most significant bits whose number is the third number among the bits whose number is the first number indicate the index identifier; or
in a case where the terminal supports the bands whose number is the third number and the third number is less than the first number, least significant bits whose number is the third number among the bits whose number is the first number indicate the index identifier.

7. The method according to claim 1, wherein the band configuration signaling is in the form of at least one of: radio resource control (RRC) signaling, a media access control control element (MAC CE), or downlink control information (DCI) signaling.

8. The method according to claim 1, further comprising:
sending capability information to the network device, wherein the capability information is configured to indicate at least one band supported by the terminal.

9. The method according to claim 8, wherein the capability information comprises at least one of:
a number of bands;
at least one of indexes of the bands or identifiers of the bands; or
an index of a band group.

10. A method for indicating a band, performed by a network device, the method comprising:
sending band configuration signaling to a terminal, wherein the band configuration signaling is configured to indicate at least one band group, the band group comprises at least two bands, and the at least two bands in the band group support switching in at least one direction.

11. The method according to claim 10, wherein;
the band configuration signaling comprises bits whose number is the first number;
each of band subgroups in the at least one band group corresponds to one bit in the band configuration signaling;
each bit corresponding to each of the band subgroups is configured to indicate whether the band subgroup is active; and;
the band subgroup comprises at least two bands.

12. The method according to claim 11, wherein:
in a case where the band group comprise the band subgroups whose number is a second number and the second number is less than the first number, most significant bits whose number is the second number among the bits whose number is the first number correspond one-to-one with the band subgroups in the band group; or
in a case where the band group comprise the band subgroups whose number is the second number and the second number is less than the first number, least significant bits whose number is the second number among the bits whose number is the first number correspond one-to-one with the band subgroups in the band group.

13. The method according to claim 12, wherein the second number of band subgroups comprised in the band group is determined based on a number of bands supported by the terminal.

14. The method according to claim 10, wherein the band configuration signaling comprises bits whose number is the first number, the bits whose number is the first number indicate an index identifier, the index identifier has a correspondence relationship with the band group, and the bits whose number is the first number are configured to indicate that the at least one band group corresponding to the indicated index identifier is active by using the indicated index identifier.

15. The method according to claim 14, wherein:
in a case where the terminal supports bands whose number is a third number and the third number is less than the first number, most significant bits whose number is the third number among the bits whose number is the first number indicate the index identifier; or
in a case where the terminal supports the bands whose number is the third number and the third number is less than the first number, least significant bits whose number is the third number among the bits whose number is the first number indicate the index identifier.

16. (canceled)

17. The method according to claim 10, further comprising:
receiving capability information sent by the terminal, wherein the capability information is configured to indicate at least one band supported by the terminal.

18-20. (canceled)

21. A terminal, the terminal comprising:
one or more processors; and
a transceiver connected to the one or more processors,
wherein the one or more processor are collectively configured to load and execute executable instructions to:
receive band configuration signaling sent by a network device, wherein the band configuration signaling is configured to indicate at least one band group, the band group comprises at least two bands, and the at least two bands in the band group support switching in at least one direction.

22. A network device, the network device comprising:
one or more processors; and
a transceiver connected to the one or more processors,
wherein the one or more processors are collectively configured to load and execute executable instructions to perform the method for indicating a band according to claim 10.

23. (canceled)

24. A non-transitory computer-readable storage medium storing an executable program code, wherein the executable program code is loaded and executed by one or more processors to implement the method for configuring a band according to claim 1.

25. A non-transitory computer-readable storage medium storing an executable program code, wherein the executable program code is loaded and executed by one or more processors to implement the method for indicating a band according to claim 10.
